(19) United States
(12) Patent Application Publication
(10) Pub. No.: US 2009/0290505 A1
(43) Pub. Date: Nov. 26, 2009

(54) DETECTION METHOD, APPARATUS AND SYSTEM FOR POSITIONING INTERFERENCE

(76) Inventor: Yang YU, Beijing (CN)

Correspondence Address: LADAS & PARRY LLP, 224 SOUTH MICHIGAN AVENUE, SUITE 1600, CHICAGO, IL, 60604, US

(21) Appl. No.: 12/470,850

(22) Filed: May 22, 2009

(30) Foreign Application Priority Data
May 26, 2008 (CN) 200810097433.8

(51) Int. Cl. H04L 12/26

(52) U.S. Cl. 370/252

(57) ABSTRACT

The present invention discloses a detection method, apparatus and system for positioning interference. The method, being applied in an EPCN including a CLT and at least one CNU connected to the CLT, includes: a CLT receiving from a CNU a packet at each uplink time slot, each CNU having a unique CNU identifier and a unique uplink time slot and determining when receiving a packet in error the CNU identifier corresponding to the uplink time slot for receiving the packet in error to position the CNU being interfered, so that the network management server can acquire physical information of the user having installed the CNU, and further accurately determine the interference source and quickly remove the failure point.

### FIELD OF THE INVENTION

The present invention relates to network communication technologies, and especially relates to a detection method, apparatus and system for positioning interference.

### BACKGROUND OF THE INVENTION

Ethernet Passive over Coax Network (EPCN) is an Ethernet running on a coaxial network, using a point-to-multipoint coaxial distribution network as a physical layer transmission medium. The coaxial distribution network can be of arbitrary topology such as star or tree topology.

Referring to FIG. 1, a typical EPCN system is formed by components such as a Coax Line Terminal (CLT), a Coax Network Unit (CNU) and a Cable Television (CATV) coaxial distribution network. The CLT is placed at a corridor or at the location where an optical node of an area is placed, and the CNU is placed at the home of a user acting as a home Customer Premises Equipment (CPE) for accessing user terminals. The CATV coaxial distribution network is a network from the location of a CATV optical node to the home of a user. The CATV coaxial distribution network is composed of coaxial cables as well as active amplifiers, splitters/distributors and other apparatus.

In the existing base-band EPCN system, a CLT can connect with multiple CNUs, and these CNUs are distributed over different user homes. As a result of different situations in different user homes, interferences that the CNUs will suffer are not the same. These interferences will affect data sent by the CNUs, and will also affect data received by the CNUs. A port of the CLT communicates with a number of CNUs connecting with the CLT through a physical tree network, so noise and interference of each tree network branch point will converge to the receiving point of the CLT. Thus, the noise level at the receiving point of the CLT is much higher than that at the point of the CNU. According to noise test results at some scenes, the noise level at the point of the CLT is 30 dB higher on average than that at the point of the CNU.

At present, since the minimum receiving levels of the CNU and the CLT are the same in the base-band EPCN system, different noise levels may cause different receiving SNR (Signal Noise Ratio) at the CLT and the CNU, and the receiving SNR of the CLT is far lower than that of the CNU. Therefore, when the base-band EPCN system is running on the network, there are many cases that the CLT receives an error packet while the CNU may not receive the error packet.

When a packet sent out from a CNU that is affected by environmental noises can not be normally received by the CLT after the packet arrives at the CLT, a network management server of the CLT can not distinguish from which CNU the received error packet is sent since the CLT may receive packets sent from all the CNUs. Therefore, the network management server of the CLT is unable to determine which CNU brings forth the interference, which has caused some difficulties for positioning/judging and removing faults on the network.

### SUMMARY OF THE INVENTION

Embodiments of the present invention provide a detection method, apparatus and system for positioning interference, in order to accurately position a CNU being interfered and remove failure points in time.

An embodiment of the present invention provides a detection method for positioning interference, being applied in an Ethernet Passive over Coax Network (EPCN) at least including a Coax Line Terminal (CLT) and at least one Coax Network Unit (CNU) connected to the CLT, the method including: receiving, by a CLT, from a CNU a packet at each uplink time slot, each CNU having a unique CNU identifier and a unique uplink time slot; and, determining when receiving a packet in error, by the CLT, the CNU identifier corresponding to the uplink time slot for receiving the packet in error to position the CNU being interfered.

An embodiment of the present invention provides a Coax Line Terminal (CLT), being configured in an Ethernet Passive over Coax Network (EPCN) and connecting to at least one Coax Network Unit (CNU) in the EPCN, the CLT being adapted to receive from a CNU a packet at each uplink time slot, each CNU having a unique CNU identifier and a unique uplink time slot, the CLT at least including: a determining module, adapted to determine, when receiving a packet in error, the CNU identifier corresponding to the uplink time slot for receiving the packet in error to position the CNU being interfered.

Compared with the related art, the embodiments of the present invention have the following advantages: by using the embodiments of the present invention, the CLT records uplink time slots allocated for CNUs connected to the CLT, and after receiving an error packet, the CLT determines the CNU sending out the error packet according to the uplink time slot to which the time period for receiving the error packet belongs, and sends the identifier of the CNU sending out the error packet to a network management server of the CLT, so that the network management server can acquire physical information of the user having installed the CNU according to the identifier of the CNU, and further accurately determine interference sources and remove failure points.

### BRIEF DESCRIPTION OF THE DRAWINGS

FIG. 1 is a typical structure of an EPCN system in the related art;

FIG. 2 is a flow chart illustrating the detection method for positioning interference in accordance with an embodiment of the present invention;

FIG. 3 is a diagram illustrating the structure of a CLT in accordance with an embodiment of the present invention;

FIG. 4 is a diagram illustrating the structure of a network management server in accordance with an embodiment of the present invention; and,

FIG. 5 is a diagram illustrating the structure of the detection system for positioning interference in accordance with an embodiment of the present invention.

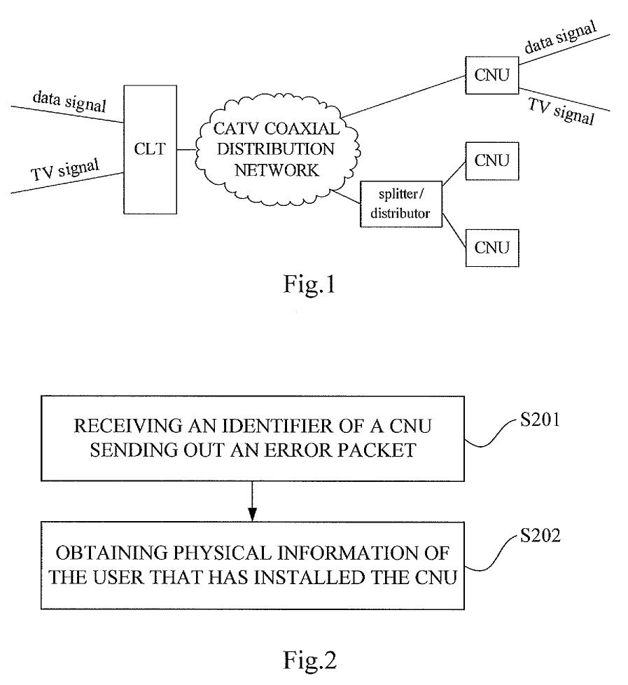

### DETAILED DESCRIPTION OF THE INVENTION

An embodiment of the present invention provides a detection method for positioning interference, the detection method is applied in an EPCN which at least includes a CLT and one or more CNU connected to the CLT. The detection method includes: receiving, by a CLT, from a CNU a packet at each uplink time slot, where each CNU has a unique CNU identifier and a unique uplink time slot; and, determining when receiving a packet in error, by the CLT, the CNU identifier corresponding to the uplink time slot for receiving the packet in error to position the CNU being interfered. Here, the CLT allocates uplink time slots for each CNU, and records the uplink time slots allocated for each CNU in each communication cycle. When receiving an error packet, the CLT determines which CNU the uplink time slot, to which the time period for receiving the error packet belongs, is allocated for, in accordance with the uplink time slots allocated for each CNU, thereby obtaining the identifier of the CNU sending out the error packet, and reports the identifier of the CNU to a network management server of the CLT, where the network management server has physical information of each CNU for positioning interference. During installation of the CNU apparatus, the network management server stores the identifier of the CNU and specific physical information of a user that has installed the CNU, and associates the identifier of the CNU to the specific physical information of the user that has installed the CNU. Hence, after receiving the identifier of the CNU reported by the CLT, the network management server can obtain specific physical information of the user according to the identifier of the CNU, so that interference sources can accurately be identified and failure points be quickly removed. Herein, the uplink time slot of the at least one CNU connected to the CLT and the downlink time slot of the CLT forms a communication cycle, where one CNU only sends packets at its own uplink time slot within the communication cycle, and do not send packets at other uplink time slots.

As shown in FIG. 2, a flowchart illustrating the detection method for positioning interference in accordance with an embodiment of the present invention includes the following steps.

Step S201; receiving an identifier of a CNU reported by a CLT. The identifier of the CNU is the identifier of a CNU that has sent out an error packet, where the CNU is determined by the CLT in accordance with an uplink time slot to which the time period for receiving the error packet belongs.

In the base-band EPCN system, the CLT allocates uplink time slots for all the CNUs connecting with the CLT. In the embodiment of the present invention, after the uplink time slots are allocated for each CNU, the CLT records the uplink time slots allocated for each of the CNUs connected to the CLT in each communication cycle.

After receiving an error packet, the CLT determines, based on the allocation of uplink time slots for each CNU connecting with the CLT, which CNU the uplink time slot to which the time period for receiving the error packet belongs is allocated for. When the uplink time slot to which the time period for receiving the error packet belongs is determined, the CLT can determine the CNU sending out the error packet according to the uplink time slot which the time period belongs to, and then report the identifier of the CNU to a network management server of the CLT. At this time, it may be determined preliminarily that the CNU may possibly be interfered at a user's home, thereby greatly narrowing the scope of fault positioning and speeding up the troubleshooting process.

Step S202: obtaining physical information of the user that has installed the CNU in accordance with the identifier of the CNU.

After a CNU apparatus is installed, the operator may store the identifier of the CNU apparatus and physical information of a user that has installed the CNU apparatus in a database of the operator. The network management server of the CLT may acquire and save the identifier of the CNU apparatus and the physical information of the user that has installed the CNU apparatus, and establish association between the identifier of the CNU having been installed and the physical information of the user that has installed the CNU. Therefore, after receiving the CNU identifier reported by the CLT, the CLT's network management server can get the physical information of the user having installed the CNU according to the CNU identifier. Specifically, the physical information of the user includes specific physical address information of the user that has installed the CNU, such as the user's residence area, the number of the building where the user lives, the unit where the user lives or the door number of the user, and the like. According to the user's physical information, the staff can look for interference sources at the home of the user like shooting the arrow at the target, which can quickly remove the point of failure.

In the foregoing detection method for positioning interference, the CLT allocates uplink time slots for the CNUs connected with the CLT, and records the uplink time slots allocated by the CLT for each CNU in a communication cycle. After receiving an error packet, the CLT determines the CNU sending out the error packet in accordance with the uplink time slot to which the time period of the received error packet belongs, and reports the identifier of the CNU sending out the error packet to the network management server of the CLT, in order to enable the network management server to obtain the physical information of the user having installed the CNU according to the identifier of the CNU, and further help to accurately determine the interference source and remove the point of failure.

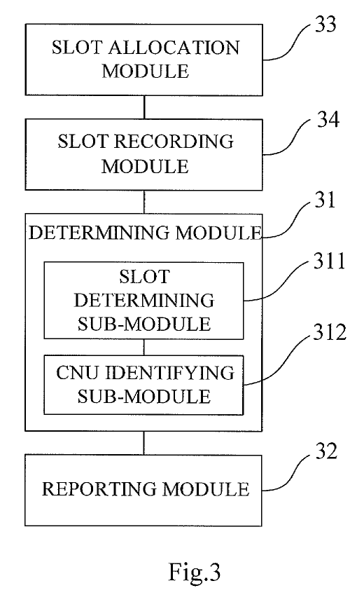

FIG. 3 shows the structure of a CLT in an embodiment of the present invention, where the CLT at least includes: a determining module 31, adapted to determine, when receiving a packet in error, the CNU identifier corresponding to the uplink time slot for receiving the packet in error to position the CNU being interfered, that is: determine the identifier of a CNU that sends out an error packet according to the uplink time slot to which the time period for receiving the error packet belongs. And the CLT may further include a reporting module 32, adapted to report the identifier of the CNU determined by the determining module 31 to a network management server of the CLT where the network management server has physical information of each CNU for positioning interference. Further, the CLT includes: a slot allocation module 33, adapted to allocate an uplink time slot for a CNU connected to the CLT, and a slot recording module 34, adapted to record uplink time slots allocated for each CNU connected to the CLT by the slot allocation module 33 in each communication cycle.

Here, the determining module 31 includes: a slot determining sub-module 311, adapted to determine the uplink time slot to which the time period for receiving the error packet belongs according to the uplink time slots allocated by the slot allocation module 33 for the CNU connected to the CLT, and a CNU identifying sub-module 312, adapted to identify the CNU corresponding to the uplink time slot determined by the slot determining sub-module 311.

In the above-mentioned CLT, the slot allocation module 33 allocates uplink time slots for each CNU connected to the CLT, and the slot recording module 34 records the uplink time slots allocated by the slot allocation module 33 for each CNU connected to the CLT in a communication cycle. After receiving an error packet, the determining module 31 determines the CNU sending out the error packet in accordance with the uplink time slot to which the time period of the received error packet belongs, and reports the identifier of the CNU to the network management server of the CLT. In this way, the network management server can obtain the physical information of the user having installed the CNU according to the GNU identifier, and further determine the interference source accurately and remove the point of failure.

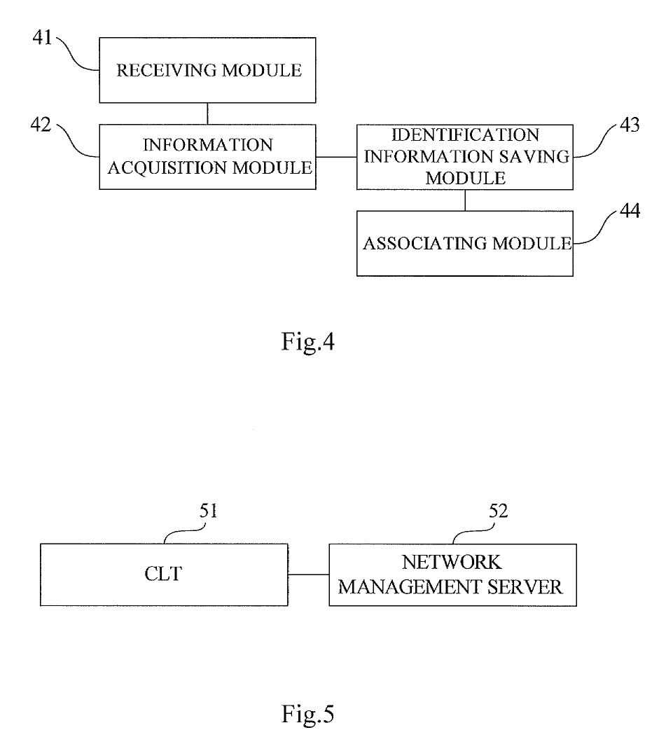

A structure of a network management server according to an embodiment of the present invention is as shown in FIG. 4. The network management server is adapted to provide services for the CLT in a base-band EPCN system, including:

a receiving module 41, adapted to receive a identifier of a CNU reported by a CLT, which is the identifier of the one sending out an error packet, and the CNU sending out the error packet is determined by the CLT in accordance with a uplink time slot to which a time period for receiving the error packet belongs; and,

an information acquisition module 42, adapted to acquire physical information of a user that has installed the CNU according to the identifier of the CNU received by the receiving module 41.

Further, the network management server includes: an identification information saving module 43, adapted to obtain and save the identifier of the CNU and the physical information of the user that has installed the CNU, and an associating module 44, adapted to establish association between the identifier of the CNU and the physical information of the user that has installed the CNU, the identifier of the CNU and the physical information being saved in the identification information saving module 43, where the association is provided for the information acquisition module 42 to acquire the physical information of the user that has installed the CNU in accordance with the identifier of the CNU.

After a CNU apparatus is installed, the operator stores the identifier of the CNU apparatus and the physical information of the user that has installed the CNU apparatus in a database of the operator. In the above-mentioned network management server, the identification information saving module 43 obtains and saves the identifier of the CNU apparatus and the physical information of the user that has installed the CNU apparatus, and the associating module 44 associates the identifier of the CNU apparatus to the physical information of the user that has installed the CNU apparatus. As a consequence, the information acquisition module 42 can acquire the physical information of the user having installed the CNU apparatus according to the identifier of the CNU apparatus received by the receiving module 41, and further interference sources can be accurately identified and points of failure can be quickly removed.

FIG. 5 is a structural diagram illustrating a detection system for positioning interference in accordance with an embodiment of the present invention. The system includes:

a CLT 51, adapted to report an identifier of a CNU, where the identifier of the CNU is the identifier of the one that has sent out an error packet, and the CNU that has sent out an error packet is determined by the CLT 51 according to the uplink time slot to which a time period for receiving the error packet belongs; and,

a network management server 52, adapted to receive the identifier of the CNU reported by the CLT 51, and obtain physical information of a user that has installed the CNU according to the identifier of the CNU.

In the above-mentioned detection system for positioning interference, the CLT 51 allocates uplink time slots for CNUs connected to the CLT 51, and records the uplink time slots the CLT 51 allocates for each CNU in a communication cycle. After receiving an error packet, the CLT 51 determines the CNU sending out the error packet in accordance with the uplink time slot to which the time period for receiving the error packet belongs, and reports the identifier of the CNU sending out the error packet to the network management server 52 of the CLT 51, to enable the network management server 52 to obtain the physical information of the user that has installed the CNU according to the identifier of the CNU. In this way, the interference source can be accurately determined, and the point of failure can be quickly removed.

Through the above description on the embodiments, those ordinarily skilled in the art can clearly understand that the embodiments of the present invention can be realized via hardware. Also, they can be achieved by using software plus a necessary common hardware platform. On the basis of this understanding, the technical scheme of the present invention can be presented in the form of a software product, where the software product can be stored in a nonvolatile storage medium (such as CD-ROM, U-disk, mobile hard disk, etc.), and it may include a number of instructions for making a computing device (such as a personal computer, a server, or a network apparatus, etc.) execute the methods described in various embodiments of the present invention.

The above mentioned contents are just specific embodiments of the present invention. However, the present invention is not limited to these embodiments. Any changes thought out by those ordinarily skilled in the art shall be falling into the protection scope of this invention.

1. A detection method for positioning interference, being applied in an Ethernet Passive over Coax Network (EPCN) at least comprising a Coax Line Terminal (CLT) and at least one Coax Network Unit (CNU) connected to the CLT, the method comprising:
receiving, by a CLT, from a CNU a packet at each uplink time slot, each CNU having a unique CNU identifier and a unique uplink time slot; and,
determining when receiving a packet in error, by the CLT, the CNU identifier corresponding to the uplink time slot for receiving the packet in error for positioning the CNU being interfered.

2. The method according to claim 1, further comprising: the uplink time slot of each CNU being allocated by the CLT.

3. The method according to claim 2, further comprising:
the uplink time slot of the at least one CNU and the downlink time slot of the CLT forming a communication cycle, the CNU only sending packets at its own uplink time slot within the communication cycle.

4. The method according to claim 1, further comprising:
sending, by the CLT, the determined CNU identifier to a network management server which has physical information of each CNU for positioning interference.

5. A Coax Line Terminal (CLT), being configured in an Ethernet Passive over Coax Network (EPCN) and connecting to at least one Coax Network Unit (CNU) in the EPCN, the CLT being adapted to receive from a CNU a packet at each uplink time slot, each CNU having a unique CNU identifier and a unique uplink time slot, the CLT at least comprising:
a determining module, adapted to determine, when receiving a packet in error, the CNU identifier corresponding to the uplink time slot for receiving the packet in error for positioning the CNU being interfered.

6. The CLT according to claim 5, further comprising:
a reporting module, adapted to report the CNU identifier determined by the determining module to a network management server which has physical information of each CNU for positioning interference.

7. The Coax Line Terminal according to claim 5, further comprising:
a slot allocation module, adapted to allocate an uplink time slot for each CNU connected to the CLT; and
a slot recording module, adapted to record the uplink time slot allocated by the slot allocation module in each communication cycle.

8. The Coax Line Terminal according to claim 5, the determining module comprising:
a slot determining sub-module, adapted to determine the uplink time slot for receiving the packet in error according to the uplink time slots allocated by the slot allocation module; and,
a CNU identifying sub-module, adapted to identify the CNU corresponding to the uplink time slot determined by the slot determining sub-module.

9. A machine readable medium having instructions stored thereon that when executed cause a computing device, being configured in an Ethernet Passive over Coax Network (EPCN) and connecting to at least one Coax Network Unit (CNU) in the EPCN, to:
receive from a CNU a packet at each uplink time slot, each CNU having a unique CNU identifier and a unique uplink time slot, and
determine, when receiving a packet in error, the CNU identifier corresponding to the uplink time slot for receiving the packet in error to position the CNU being interfered.
